(19) United States
(12) Patent Application Publication
(10) Pub. No.: US 2004/0070878 A1
(43) Pub. Date: Apr. 15, 2004

(54) Magnetic head having magnetic core half which is fixed by deformation processing and method for manufacturing the same

(76) Inventor: Masatomi Abe, Niigata-ken (JP)

Correspondence Address: BRINKS HOFER GILSON & LIONE, P.O. BOX 10395, CHICAGO, IL, 60610, US

(21) Appl. No.: 10/631,680

(22) Filed: Jul. 31, 2003

(30) Foreign Application Priority Data
Aug. 9, 2002 (JP) 2002-234069

(51) Int. Cl. G11B 5/10

(52) U.S. Cl. 360/129

(57) ABSTRACT

In a magnetic head according to the present invention, a base is provided with at least one first positioning hole and a magnetic core half has a back portion which is disposed in the first positioning hole. In addition, the base is further provided with at least one first recess at the periphery of the first positioning hole and the base is partially deformed due to the first recess such that a portion of the base at the periphery of the first positioning hole is shifted to press the back portion of the magnetic core half against an inner side of the first positioning hole. Accordingly, the present invention provides a magnetic head in which the magnetic core half can be reliably fixed to the base and a method for manufacturing the magnetic head.

### BACKGROUND OF THE INVENTION

1. Field of the Invention

The present invention relates to magnetic heads and magnetic-head manufacturing methods.

2. Description of the Related Art

As an example of a two-channel magnetic recording/reproducing head for audio, a magnetic head 106 shown in FIG. 11 is known in the art. In the magnetic head 106, two magnetic core halves 100 and 101, each of which is formed by laminating a plurality of C-shaped magnetic plates, are attached to a base 102, and the base 102 and another base which is constructed similarly to the base 102 is stored in a shield case 105.

The base 102 is provided with columnar projections 108 and 109 which project from the base 102, the magnetic core halves 100 and 101 and a shield plate 112 interposed therebetween are fixed while being placed in a gap 113 between restraining tabs 110 and 111 which are formed by folding the base 102 at one edge thereof. More specifically, the magnetic core half 100 is placed between the projection 108 and the restraining tab 110, the magnetic core half 101 is placed between the projection 109 and the restraining tab 111, and the shield plate 112 is placed between the magnetic core halves 100 and 101 and between the projections 108 and 109.

In addition, front-end portions 100A and 101A of the magnetic core halves 100 and 101, respectively, and a front-end portion 112A of the shield plate 112 project out from the base 102 and face out through a window 115 formed in the shield case 105. Although not shown in FIG. 11, another base having the same shape as that of the base 102 is also stored in the shield case 105, and magnetic core halves and a shield plate having the same shapes as those of the magnetic core halves 100 and 101 and the shield plate 112, respectively, are attached to this base. The magnetic core half 100 shown in FIG. 11 and one of the magnetic core halves not shown in FIG. 11 which faces magnetic core half 100 form a single magnetic core. In addition, the magnetic core half 101 and the other one of the magnetic core halves not shown in FIG. 11 which faces magnetic core half 101 also form a single magnetic core. Accordingly, the magnetic head 106 which serves as a two-channel magnetic recording/reproducing head is obtained.

In FIG. 11, the line denoted by S shows a final grinding line. When the pair of magnetic cores are stored in the shield case 105 in the manner shown in FIG. 11, an adhesive resin is injected into the shield case 105 so as to form an adhesive layer. After the adhesive resin is dried and cured, the surface of the shield case 105, the front-end portions 100A and 101A of the magnetic core halves 100 and 101, respectively, and the front-end portion 112A of the shield plate 112 are subjected to final grinding and are grinded by a necessary amount along the final grinding line S. Thus, a magnetic gap and a sliding surface with respect to a magnetic tape are defined and the magnetic head is obtained as a final product.

The magnetic core halves 100 and 101 and the shield plate 112 are attached to the base 102 having the construction shown in FIG. 11 by the following processes. That is, while the base 102 is supported in a horizontal position, the magnetic core halves 100 and 101 and the shield plate 112 are placed between the projection 108 and the restraining tab 110, between the projection 108 and the projection 109, and between the projection 109 and the restraining tab 111, respectively, with forceps. Then, an adhesive such as an epoxy resin is applied to parts where the base 102 is in contact with the magnetic core halves 100 and 101 and the shield plate 112, and is dried and cured by heating it in drying equipment at about 150° C. to 200° C. for several hours. Then, after the adhesive is completely cured, a surface-grinding step is performed.

In the surface-grinding step, end surfaces of the C-shaped magnetic core halves 100 and 101 and the shield plate 112, which are fixed on the base 102, are grinded. More specifically, as shown in FIG. 12, the base 102 to which the magnetic core halves 100 and 101 are attached is placed on a table 120 of a grinding machine, and a disc-shaped grinding plate 121 is moved downward while being rotated. A grinding surface 121A of the grinding plate 121 grinds a front-end surface 100a and a rear-end surface 100b of the magnetic core half 100 by necessary amounts so as to make the front-end and rear-end surfaces 100a and 100b of the magnetic core half 100 even. The base 102 is combined with another base which is constructed similarly to the base 102 after the surface grinding process such that the C-shaped magnetic core halves which form a pair face each other with a gap therebetween. Accordingly, annular magnetic cores are obtained. The pair of bases 102 and 102 which are combined as described above are inserted into the shield case 105 shown in FIG. 12, and each of the magnetic cores is positioned with respect to the window 115. Then, an adhesive resin is injected into the shield case 105, and is dried and cured so that the magnetic cores are fixed to the shield case 105. Then, final grinding is performed and the magnetic head is completed.

In the above-described magnetic-head manufacturing method, the magnetic core halves 100 and 101 and the shield plate 112 are manually placed on the base 102 using a tool such as forceps. However, when these components are placed manually, there is a limit to the positioning accuracy thereof. In addition, since it is not possible to handle many components in a short time, high manufacturing costs are incurred. Since the attachment accuracy of the magnetic core halves 100 and 101 and the shield plate 112 directly affects the shape of a gap portion which has an influence on the performance of the magnetic head, it is important to increase the attachment accuracy.

The magnetic core halves 100 and 101 and the shield plate 112 may also be attached to the base 102 by using an automatic machine, such as a robot, which performs the above-described task. However, since magnetic heads of various shapes are simultaneously manufactured in short-term lots and the shapes of the magnetic heads are often changed, the automatic machine must often be modified in accordance with such changes. Therefore, complex maintenance of the automatic machine is required and high manufacturing costs are incurred.

In order to partly solve the above-described problems, a construction shown in FIG. 13 is known in the art. With reference to FIG. 13, magnetic core halves 130 and 131 are provided with projecting portions 130a and 131a, respectively, on the back (on the peripheral surfaces of the C-shaped cores), and a projecting portion 132a is formed on the back of a shield plate 132. In addition, slits 135, 136, and 137 for receiving the projecting portions 130a, 131a, and 132a, respectively, are formed in the base 138, and a base block 140 having grooves 139 for receiving the magnetic core halves 130 and 131 and the shield plate 132 is provided on the base 138 at one end thereof. Accordingly, the magnetic core halves 130 and 131 and the shield plate 132 can be accurately positioned.

In the construction shown in FIG. 13, since a fixing force obtained by fitting the projecting portions 130a to 132a into the slits 135 to 137, respectively, is not very strong and sufficient stability cannot be obtained, an adhesive must be applied, and be dried and cured in order to fix the magnetic core halves 130 and 131 and the shield plate 132 with sufficient strength.

In addition, even when the magnetic core halves 130 and 131 and the shield plate 132 are press-fitted into the slits 135 to 137, respectively, the fixing strength is not sufficient. On the contrary, there is a risk that excessive stress will be applied to the magnetic core halves 130 and 131 and the shield plate 132 and physical strain or degradation of magnetic performance will occur.

### SUMMARY OF THE INVENTION

In view of the above-described situation, an object of the present invention is to provide a magnetic head in which a magnetic core half can be reliably fixed to a base and a method for manufacturing the magnetic head.

In order to achieve the above-described object, according to the present invention, a magnetic head includes at least one magnetic core unit which includes a base and at least one magnetic core half attached to the base and a shield case which has a window and which accommodates the magnetic core unit. The base is provided with at least one first positioning hole, and the magnetic core half has a back portion which is disposed in the first positioning hole. In addition, the base is further provided with at least one first recess at the periphery of the first positioning hole, and the base is partially deformed due to the first recess such that a portion of the base at the periphery of the first positioning hole is shifted to press the back portion of the magnetic core half against an inner side of the first positioning hole.

In the magnetic head according to the present invention, the magnetic core unit is constructed by attaching the magnetic core half to the base, and is stored in the shield case having the window.

When the first recess is formed by, for example, a punch at the periphery of the first positioning hole while the back portion of the magnetic core half is inserted in the first positioning hole, at least a portion of the base which corresponds to the volume of the first recess moves toward the magnetic core half. As a result, the portion of the base at the periphery of the first positioning hole presses the back portion of the magnetic core half against the inner side of the first positioning hole. Therefore, the magnetic core half can be strongly fixed.

In the magnetic head according to the present invention, preferably, the first positioning hole has a substantially rectangular shape in a plan view and includes expanding portions which increase the opening area of the first positioning hole at the corners of the first positioning hole, and the first recess connects the expanding portions on one side of the first positioning hole.

In such a case, compared to the case in which the expanding portions are not formed at the corners of the first positioning hole, the space for receiving the magnetic core half can be ensured. Accordingly, the magnetic core half can be easily assembled.

In addition, since the first recess connects the expanding portions on one side of the first positioning hole, the volume of a portion of the base between the first positioning hole and the first recess is constant along the longitudinal direction of the first recess. Accordingly, when the first recess is formed, a portion of the base which corresponds to at least a part of the volume of the first recess moves toward the magnetic core half in a uniform manner along the longitudinal direction of the first recess. As a result, the magnetic core half is pressed against the inner side of the first positioning hole with a force which is approximately constant along the longitudinal direction of the first positioning hole. Therefore, the magnetic core half can be stably fixed.

In addition, in the magnetic head according to the present invention, the first recess may include a first wall which is adjacent to the first positioning hole and which is inclined with respect to the bottom surface of the first recess.

In such a case, compared to the case in which the first wall is not inclined, a portion of the base which corresponds to at least a part of the volume of the first recess can more easily move toward the first positioning hole than toward the surface of the base when the first recess is formed. As a result, the amount by which the portion of the base moves toward the magnetic core half increases and the magnetic core half can be pressed against the inner side of the first positioning hole with a relatively large force. Therefore, the magnetic core half can be more strongly fixed.

In addition, in the magnetic head according to the present invention, the first recess may also include a second wall which is remote from the first positioning hole and which is inclined with respect to the bottom surface of the first recess.

In such a case, compared to the case in which the second wall is not inclined, a portion of the base which is adjacent to the second wall more easily moves toward the magnetic core half. As a result, since the portion of the base which moves toward the magnetic core half does not move toward the surface of the base at a region near the second wall when the first recess is formed, swelling of the surface of the base can be prevented.

In addition, in the magnetic head according to the present invention, the magnetic core unit may include a plurality of the magnetic core halves and the base may be provided with a plurality of the first positioning holes, each of the magnetic core halves having a back portion which is disposed in one of the first positioning holes. In this case, at least one shield plate is attached to the base such that the shield plate is disposed between the adjacent magnetic core halves. In addition, the base is provided with at least one second positioning hole at a position between the adjacent first positioning holes and the shield plate has a back portion which is disposed in the second positioning hole. In addition, the base is further provided with at least one second recess at the periphery of the second positioning hole and the base is partially deformed due to the second recess such that a portion of the base at the periphery of the second positioning hole is shifted to press the back portion of the shield plate against an inner side of the second positioning hole.

Accordingly, the magnetic head includes a plurality of magnetic core halves and the base is provided with a plurality of first positioning holes for receiving the back portions of the magnetic core halves. In addition, the back portion of the shield plate is inserted into the second positioning hole formed in the base.

When the second recess is formed by, for example, a punch at the periphery of the second positioning hole while the back portion of the shield plate is inserted in the second positioning hole, at least a portion of the base which corresponds to the volume of the second recess moves toward the shield plate. As a result, the portion of the base at the periphery of the second positioning hole presses the back portion of the shield plate against the inner side of the second positioning hole. Therefore, the shield plate can be strongly fixed.

In addition, in the magnetic head according to the present invention, the second recess may include a first wall which is adjacent to the second positioning hole and which is included with respect to the bottom surface of the second recess and a second wall which is remote from the second positioning hole and which is inclined with respect to the bottom surface of the second recess.

When the first wall of the second recess which is adjacent to the second positioning hole is inclined, a portion of the base which corresponds to at least a part of the volume of the second recess can more easily move toward the shield plate when the second recess is formed. As a result, the amount by which the portion of the base moves toward the shield plate increases and the shield plate can be pressed against the inner side of the second positioning hole with a relatively large pressing force. Therefore, the shield plate can be more strongly fixed.

In particular, when the second recess is formed at each side of the second positioning hole, the shield place can be pressed from both sides, and the shield plate can be more reliably fixed.

In addition, when the second wall of the second recess which is remote from the second positioning hole is inclined, compared to the case in which the second wall is not inclined, a portion of the base which is adjacent to the second wall more easily moves toward the shield plate. As a result, since the portion of the base which moves toward the shield plate and does not move toward the surface of the base at a region near the second wall when the second recess is formed, swelling of the surface of the base can be prevented.

In addition, in the magnetic head according to the present invention, the first recess is preferably provided adjacent to at least one of longitudinal sides of the first positioning hole.

When the first recess is formed, a portion of the base which is adjacent to the first positioning hole on the same side as the first recess moves toward the magnetic core half and presses the magnetic core half against the inner side of the first positioning hole. At this time, the longitudinal inner side which is remote from the first recess receives the magnetic core half. Accordingly, the inner side of the first positioning hole which is remote from the first recess serve as a positioning member. As a result, the magnetic core half can be positioned in a direction approximately perpendicular to the longitudinal direction of the first positioning hole.

In addition, in the magnetic head according to the present invention, the magnetic core half may include a plurality of magnetic plates which are laminated to each other, and the base may be provided with a position-restricting portion which restricts the position of the magnetic core half by pressing the magnetic core half.

When the base is provided with the position-restricting portion, the position of a front-end portion of the magnetic core half can be adjusted and the displacements of the magnetic plates included in the magnetic core half can be prevented. In addition, in the case in which the shield plate is interposed between two magnetic core halves, the distances between the shield plate and the magnetic core halves can be adjusted and the accuracy of the positional relationship between the shield plate and the magnetic core halves can be increased.

In addition, in the magnetic head according to the present invention, an inclination angle of the first wall of the first recess with respect to the bottom surface of the first recess may be smaller than an inclination angle of the second wall of the first recess with respect to the bottom surface of the first recess.

In such a case, compared to the case in which the inclination angle of the first wall is larger than that of the second wall, the volume of the portion of the base positioned between the magnetic core half and the first recess can be increased. Therefore, a larger portion of the base can move toward the magnetic core half, and the magnetic core half can be pressed against the inner side of the first positioning hole with a relatively strong force. As a result, the magnetic core half can be more reliably fixed.

In addition, in the magnetic head according to the present invention, an inclination angle of the first wall of the second recess with respect to the bottom surface of the second recess may be smaller than an inclination angle of the second wall of the second recess with respect to the bottom surface of the second recess.

In such a case, compared to the case in which the inclination angle of the first wall is larger than that of the second wall, the volume of the portion of the base positioned between the shield plate and the second recess can be increased. Therefore, a larger portion of the base can move toward the shield plate, and the shield plate can be pressed against the inner side of the second positioning hole with a relatively strong force. As a result, the magnetic core half can be more reliably fixed.

In addition, in the magnetic head according to the present invention, the first positioning hole may be provided with a projection on an inner side thereof, the projection being in contact with at least a part of the magnetic core half. In such a case, the magnetic core half can be reliably fixed.

In addition, in the magnetic head according to the present invention, the second positioning hole may be provided with a projection on an inner side thereof, the projection being in contact with at least a part of the shield plate. In such a case, the shield plate can be reliably fixed.

In addition, in the magnetic head according to the present invention, the back portion of the magnetic core half may include a contact portion which is in contact with the surface of the base and a projection provided on the contact portion, the projection being disposed in the first positioning hole.

In such a case, since contact portion which is in contact with the surface of the base, the magnetic core half can be positioned in the direction in which the back portion of the magnetic core half is inserted into the first positioning hole.

According to another aspect of the present invention, a magnetic head includes at least one magnetic core unit which includes a base, a plurality of magnetic core halves attached to the base, and at least one shield plate attached to the base such that such that the shield plate is disposed between the adjacent magnetic core halves and a shield case which has a window and which accommodates the magnetic core unit. The base is provided with at least one second positioning hole and the shield plate has a back portion which is disposed in the second positioning hole. In addition, the base is further provided with at least one second recess at the periphery of the second positioning hole and the base is partially deformed due to the second recess such that a portion of the base at the periphery of the second positioning hole is shifted to presses the back portion of the shield plate against an inner side of the second positioning hole.

In the magnetic head according to the present invention, the magnetic core unit is constructed by attaching the magnetic core halves and the shield plate to the base such that the shield plate is interposed between the magnetic core halves, and is stored in the shield case having the window.

When the second recess is formed by, for example, a punch at the periphery of the second positioning hole while the back portion of the shield plate is inserted in the second positioning hole, at least a portion of the base which corresponds to the volume of the second recess moves toward the shield plate. As a result, the portion of the base at the periphery of the second positioning hole presses the back portion of the shield plate against the inner side of the second positioning hole. Therefore, the shield plate can be strongly fixed.

In the magnetic head according to the present invention, preferably, the second positioning hole has a substantially rectangular shape in a plan view and includes expanding portions which increase the opening area of the second positioning hole at the corners of the second positioning hole, and the second recess connects the expanding portions on one side of the second positioning hole.

In such a case, compared to the case in which the expanding portions are not formed at the corners of the second positioning hole, the space for receiving the shield plate can be ensured. Accordingly, the shield plate can be easily assembled.

In addition, since the second recess connects the expanding portions on one side of the second positioning hole, the volume of a portion of the base between the second positioning hole and the second recess is constant along the longitudinal direction of the second recess. Accordingly, when the second recess is formed, a portion of the base which corresponds to at least a part of the volume of the second recess moves toward the shield plate in a uniform manner along the longitudinal direction of the second recess. As a result, the shield plate is pressed against the inner side of the second positioning hole with a force which is approximately constant along the longitudinal direction of the second positioning hole. Therefore, the shield plate can be stably fixed.

In addition, the magnetic head according to the present invention may include a pair of the magnetic core units which are combined together such that a gap portion is provided between the magnetic core halves of the magnetic core units, and the magnetic core units may be stored in the shield case such that the gap portion faces out through the window of the shield case.

Accordingly, the magnetic head according to the present invention may be used as a multi-channel (for example, two-channel) magnetic recording/reproducing head for audio. Therefore, magnetic core halves of a multi-channel (for example, two-channel) magnetic recording/reproducing head for audio can be strongly fixed.

In addition, according to another aspect of the present invention, a method for manufacturing a magnetic head including at least one magnetic core unit and a shield case which has a window and which accommodates the magnetic core unit, the magnetic core unit including a base and at least one magnetic core half which has a back portion and which is attached to the base, includes a magnetic-core-half-inserting step of inserting the back portion of the magnetic core half into a first positioning hole which is formed in the base, and a recess-forming step of forming at least one first recess at the periphery of the first positioning hole so that the base is partially deformed and a portion of the base at the periphery of the first positioning hole is shifted to press the back portion of the magnetic core half against an inner side of the first positioning hole.

When the first recess is formed, a portion of the base which corresponds to at least a part of the volume of the first recess moves toward the magnetic core half. As a result, the portion of the base at the periphery of the first positioning hole presses the back portion of the magnetic core half against the inner side of the first positioning hole. Therefore, the magnetic core half can be strongly fixed.

In the method for manufacturing a magnetic head according to the present invention, preferably, the first positioning hole has a substantially rectangular shape in a plan view and the method further comprises an expanding-portion-forming step of forming expanding portions which increase the opening area of the first positioning hole at the corners of the first positioning hole, the expanding-portion-forming step being performed before the recess-forming step. In addition, the first recess is preferably formed so as to connect the expanding portions on one side of the first positioning hole in the recess-forming step.

When the first recess connects the expanding portions on one side of the first positioning hole, the volume of a portion of the base between the first positioning hole and the first recess is constant along the longitudinal direction of the first recess. Accordingly, when the first recess is formed, a portion of the base which corresponds to at least a part of the volume of the first recess moves toward the magnetic core half in a uniform manner along the longitudinal direction of the first recess. As a result, the magnetic core half is pressed against the inner side of the first positioning hole with a force which is approximately constant along the longitudinal direction of the first positioning hole. Therefore, the magnetic core half can be stably fixed.

In addition, according to another aspect of the present invention, a method for manufacturing a magnetic head including at least one magnetic core unit and a shield case which has a window and which accommodates the magnetic core unit, the magnetic core unit including a base, a plurality of magnetic core halves attached to the base, and at least one shield plate which is attached to the base such that the shield plate is disposed between the adjacent magnetic core halves and which has a back portion, includes a shield-plate-inserting step of inserting the back portion of the shield plate into a second positioning hole which is formed in the base and a recess-forming step of forming at least one second recess at the periphery of the second positioning hole so that the base is partially deformed and a portion of the base at the periphery of the second positioning hole is shifted to press the back portion of the shield plate against an inner side of the second positioning hole.

When the second recess is formed, a portion of the base which corresponds to at least a part of the volume of the second recess moves toward the shield plate. As a result, the portion of the base at the periphery of the second positioning hole presses the back portion of the shield plate against the inner side of the second positioning hole. Therefore, the shield plate can be strongly fixed.

In the method for manufacturing a magnetic head according to the present invention, preferably, the second positioning hole has a substantially rectangular shape in a plan view and the method further comprises an expanding-portion-forming step of forming expanding portions which increase the opening area of the second positioning hole at the corners of the second positioning hole, the expanding-portion-forming step being performed before the recess-forming step. In addition, the second recess is formed so as to connect the expanding portions on one side of the second positioning hole in the recess-forming step.

When the second recess connects the expanding portions on one side of the second positioning hole, the volume of a portion of the base between the second positioning hole and the second recess is constant along the longitudinal direction of the second recess. Accordingly, when the second recess is formed, a portion of the base which corresponds to at least a part of the volume of the second recess moves toward the shield plate in a uniform manner along the longitudinal direction of the second recess. As a result, the shield plate is pressed against the inner side of the second positioning hole with a force which is approximately constant along the longitudinal direction of the second positioning hole. Therefore, the shield plate can be stably fixed.

In addition, in the method for manufacturing the magnetic head according to the present invention, the first recess or the second recess may be formed with an indenting tool in the recess-forming step, and the indenting tool may include a projection which is pressed into the base and a flat portion which comes into contact with the surface of the base and prevents the surface of the base from swelling when the projection is pressed into the base.

When the projection if the indenting tool is pressed into the base, a portion of the base tries to move upward. However, since the surface of the base is pressed downward by the flat portion, the portion of the base cannot move upward and moves toward the magnetic core half or the shield plate. As a result, the pressing force applied to the magnetic core half or the shield plate can be increased and swelling of the surface of the base can be prevented.

### BRIEF DESCRIPTION OF THE DRAWINGS

FIG. 1 is a partial cross section showing a state in which a magnetic core unit included in a magnetic head according to a first embodiment of the present invention is stored in a shield case;

FIG. 2 is a partial cross section of a part of the magnetic head in the state in which magnetic core units are stored in the shield case;

FIG. 3 is a plan view of a positioning hole for a magnetic core half which is formed in a base included in the magnetic head according to the first embodiment of the present invention;

FIG. 4 is a sectional view showing the state in which a projecting portion of the magnetic core half is inserted into the positioning hole and fixed;

FIG. 5 is a perspective view showing the state in which magnetic core halves and a shield plate is fixed to the base included in the magnetic head according to the first embodiment of the present invention;

FIG. 6 is a plan view of a positioning hole for the shield plate which is formed in the base included in the magnetic head according to the first embodiment of the present invention;

FIGS. 7A to 7C are plan views showing modifications of expanding portions which increases the opening area of each positioning hole formed in the base included in the magnetic head according to the first embodiment of the present invention;

FIG. 8 is an exploded perspective view of magnetic core units included in a magnetic head according to a second embodiment of the present invention;

FIG. 9 is an exploded perspective view of the magnetic head according to a second embodiment of the present invention;

FIG. 10 is a plan view showing a base included in the magnetic head according to the second embodiment of the present invention;

FIG. 11 is a partial cross section of a known magnetic core unit in a state in which the magnetic core unit is stored in a shield case.

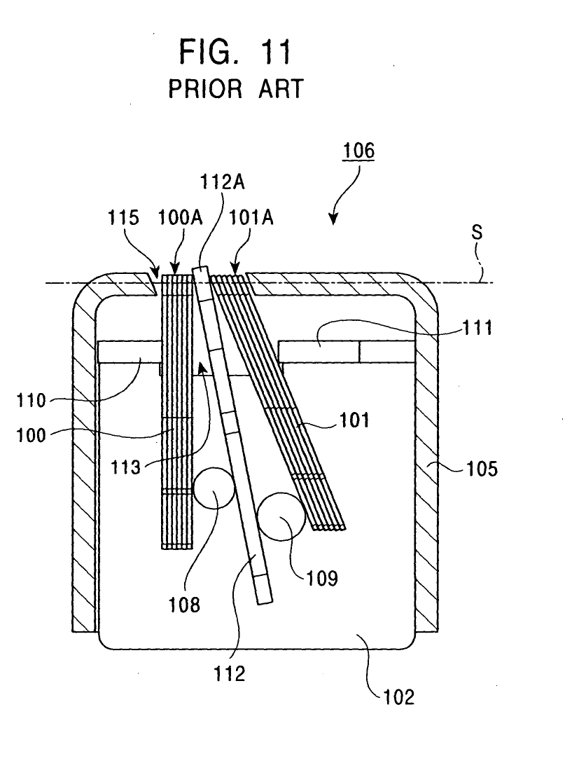

FIG. 12 is a diagram showing the manner in which the known magnetic core unit is grinded by a grinding machine; and

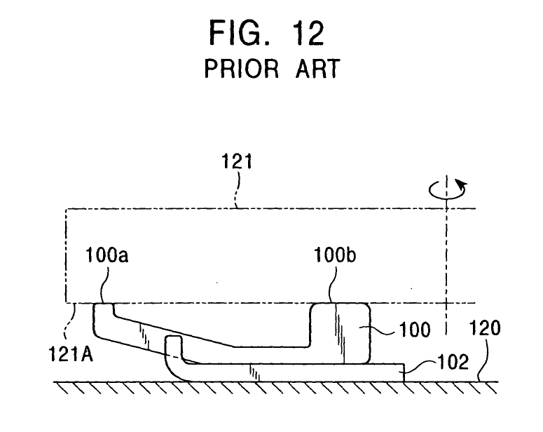

FIG. 13 is an exploded view of another example of a know magnetic core unit.

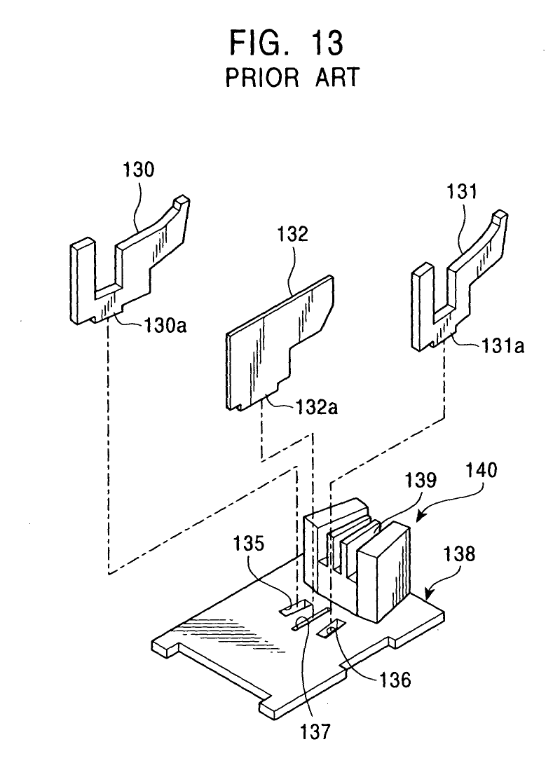

### DESCRIPTION OF THE PREFERRED EMBODIMENTS

A magnetic head and a magnetic-head manufacturing method according to a first embodiment of the present invention will be described below with reference to the accompanying drawings.

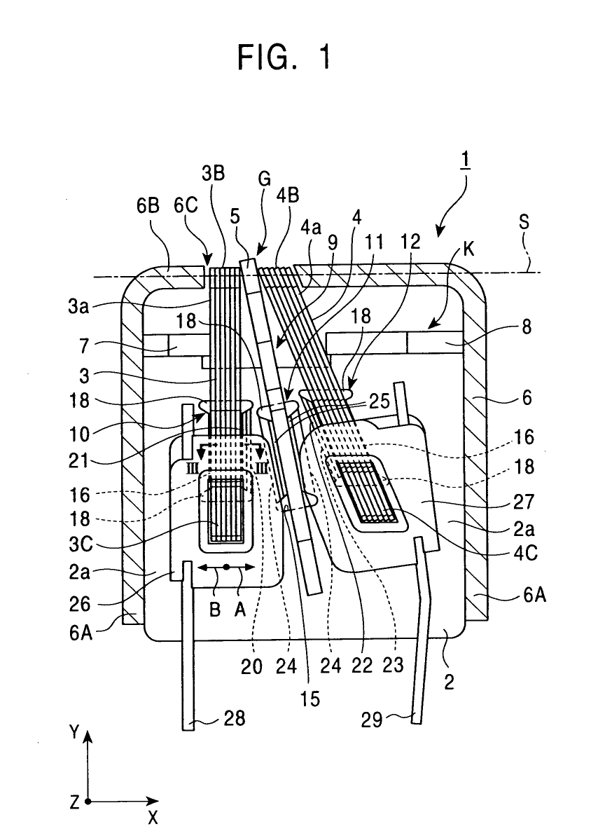

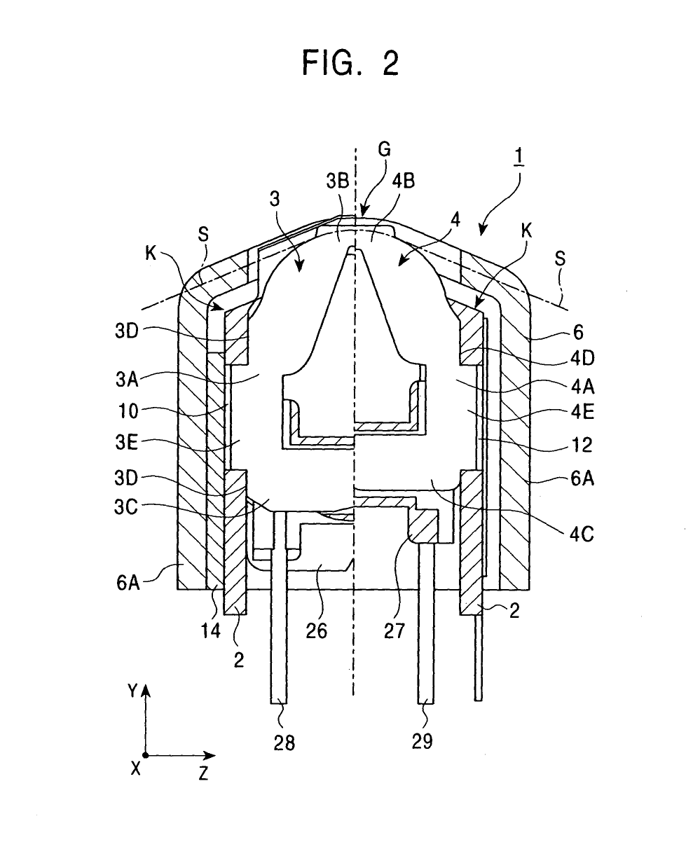

As shown in FIGS. 1 and 2, a magnetic head 1 according to the present invention is constructed by combining two magnetic core units K, each of which includes a base 2, magnetic core halves 3 and 4, and a shield plate 5, and storing the combined body in a shield case 6.

In the present embodiment, the shield case 6 includes a rectangular peripheral wall 6A and a front wall 6B which closes the peripheral wall 6A at one side thereof. The peripheral wall 6A and the front wall 6B are integrally formed by drawing of metal, etc., and a window 6C is formed in the front wall 6B. FIGS. 1 and 2 show sectional views of the magnetic head in a state before the front wall 6B of the shield case 6 is grinded along a grinding line S so as to complete the magnetic head. A sliding surface with respect to a magnetic medium, such as a magnetic tape, and a gap is accurately defined by grinding the front wall 6B along the grinding line S, and the magnetic head is thus completed as a final product.

The base 2 is constructed of a plate composed of a metal, such as brass, which can be subjected to plastic forming, and has a rectangular shape in a plan view. The size of the base 2 is such that approximately the entire body of the base 2 can be fitted inside the shield case 6 with an edge portion slightly protruding from the shield case 6. In addition, the base 2 is provided with restraining tabs 7 and 8 which are formed by folding the base 2 at one edge thereof. The restraining tabs 7 and 8 are separated from each other in the horizontal direction in FIG. 1, and a gap 9 for receiving and supporting the magnetic core halves 3 and 4 and the shield plate 5 is provided between the restraining tabs 7 and 8. The base 2 is stored in the shield case 6 in such a manner that the restraining tabs 7 and 8 are positioned near the bottom of the shield case 6 and side portions 2a of the base 2 is in contact with the inner walls of the shield case 6. In addition, a spacer 14 for provisionally fixing the pair of magnetic core units K to the shield case 6 is placed in the shield case 6. Alternatively, instead of using the spacer 14, a projection may be formed on the peripheral wall 6A of the shield case 6. When the magnetic core halves 3 and 4 are attached to the base 2, the restraining tabs 7 and 8 serve as position-restricting portions which bring front-end portions 3B and 4B of the magnetic core halves 3 and 4, respectively, into contact with the shield plate 5 and presses the magnetic core halves 3 and 4 so as to prevent magnetic plates included in the magnetic core halves 3 and 4 from being displaced and the front-end portions 3B and 4B from being separated from each other. Accordingly, when final grinding along the line S is performed, distances between the shield plate 5 and the magnetic core halves 3 and 4 and between the front-end portions 3B and 4B of the magnetic core halves 3 and 4, respectively, are set with high accuracy.

The base 2 is provided with slit-shaped positioning holes 10, 11, and 12 which are arranged next to each other at a region near the gap 9 such that the positioning holes 10, 11, and 12 extend toward the window 6C of the shield case 6. The positioning hole 10 is on the left in FIG. 1 and is oriented approximately vertically in FIG. 1 toward the window 6C, the positioning hole 11 is at the center in FIG. 1 and is oriented slightly to the left toward the window 6C, and the positioning hole 12 is on the right in FIG. 1 and is oriented further to the left toward the window 6C. In other words, the slit-shaped positioning holes 10, 11, and 12 are disposed such that center lines of the positioning holes 10, 11, and 12 intersect at a single point outside the window 6C of the shield case 6. Since the positioning holes 10, 11, and 12 serve approximately the same function, the positioning hole 10 will be described in detail below as an example. Although the orientations and shapes of the positioning holes 11 and 12 are slightly different from those of the positioning hole 10, functions of the positioning holes 11 and 12 are the same as that of the positioning hole 10. Accordingly, portions of the positioning holes 10, 11, and 12 which serve the same functions are denoted by the same reference numerals.

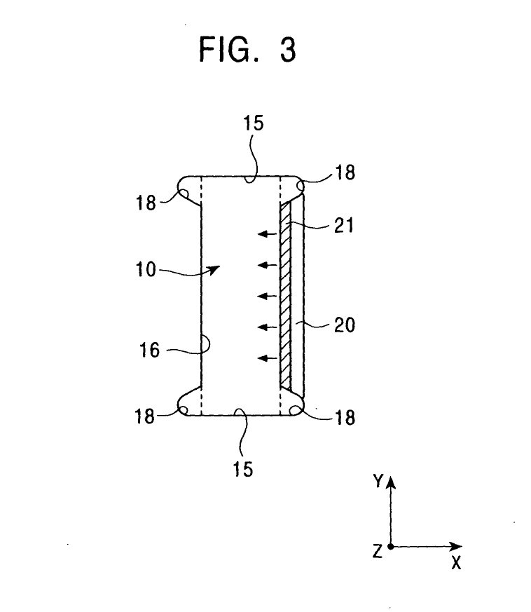

The positioning hole 10 is a slit-like opening which extends through the base 2 in the thickness direction thereof. As shown in FIG. 3, the positioning hole 10 has a rectangular shape in a plan view and includes short sides 15 and 15 which face each other and long sides 16 and 16 which also face each other. In addition, round-shaped expanding portions (relief portions) 18 which expand outward from both ends of each of the long sides 16 so as to enlarge the opening are formed at four corners of the positioning hole 10. The shape of the expanding portions 18 is determined such that they do not expand outward beyond the short sides 15 and 15. It is not necessary that the positioning hole 10 extend through the base 2, and the positioning hole 10 may also be formed as a recess which does not extend through the base 2.

Expanding portions 18 at the corners of the positioning holes 11 and 12 are constructed similarly to the expanding portions 18 at the corners of the positioning hole 10, and explanations thereof are thus omitted.

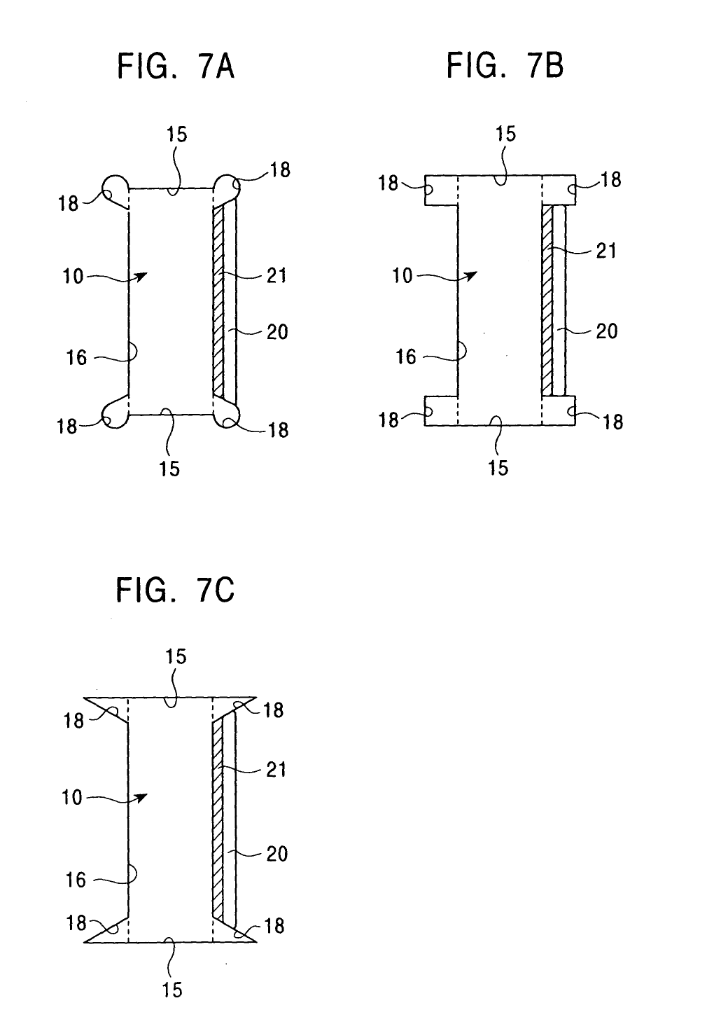

The shape of the expanding portions 18 is not limited to the above-described shape, and they may also have a circular shape as shown in FIG. 7A, a rectangular shape as shown in FIG. 7B, or a wedge shape as shown in FIG. 7C. In particular, when the expanding portions 18 have a circular shape, burrs do not easily occur when the base 2 is cut to form the expanding portions 18 and it is not necessary to remove the burrs afterwards. Accordingly, the magnetic head 1 can be easily manufactured.

The magnetic core half 3 having a shape described below is fixed to the base 2 by using the above-described positioning hole 10.

As shown in FIG. 2, the magnetic core half 3 is C-shaped and includes a long, rectangular-plate shaped main portion 3A, the front-end portion 3B formed at one end of the main portion (contact portion) 3A, and a back-core portion 3C formed at the other end of the main portion 3A. In addition, a flat portion 3D is formed on the back of the main portion 3A (at the periphery of the C-shaped magnetic core half 3), and a projecting portion 3B is formed at the central region of the flat portion 3D. The length, that is, the projecting length, of the projecting portion 3E is preferably slightly smaller than the thickness of the base 2. In addition, the thickness of the projecting portion 3E, that is, the thickness of the magnetic core half 3, is approximately the same as the distance between the long sides 16 and 16 of the positioning hole 10, and the width of the projecting portion 3E along the longitudinal direction of the main portion 3A is approximately the same as the distance between the short sides 15 and 15 of the positioning hole 10. Accordingly, the projecting portion 38 can be tightly or loosely fitted into the positioning hole 10. More specifically, the thickness of the projecting portion 3E may be slightly smaller than the distance between the long sides 16 and 16 of the positioning hole 10 and the width of the projecting portion 3E may be set slightly smaller than the distance between the short sides 15 and 15 of the positioning hole 10, so that the projecting portion 3E can be loosely fitted in the positioning hole 10.

The magnetic core half 3 according to the present embodiment is composed of a magnetic material, such as NiFe. In addition, as shown In FIG. 1, the magnetic core half 3 has a laminate structure obtained by laminating six thin magnetic plates 3a, each of which is about 0.1 mm thick, with adhesive layers of epoxy resin or the like therebetween. Alternatively, however, the magnetic core half 3 may of course be constructed of a single thick magnetic plate.

The magnetic core half 4 has basically the same shape as that of the magnetic core half 3. More specifically, the magnetic core half 4 is also C-shaped and includes a main portion 4A, the front-end portion 4B, a back-core portion 4C, a flat portion 4D, and a projecting portion 4E, and has a laminate structure obtained by laminating six magnetic plates 4a.

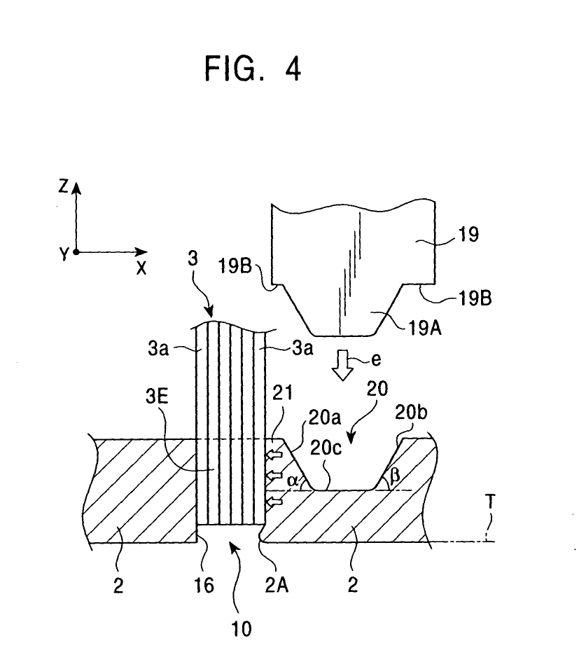

The projecting portion 3E is inserted or fitted into the positioning hole 10 while the flat portion 3D is pressed against the surface of the base 2. Then, as shown in FIG. 4, a recess 20 is formed in the base 2 by an indenting tool 19, such as a punch, at a position between the expanding portions 18 and 18 on one side of the positioning hole 10, so that a spreading portion 21 which is shifted due to the recess 20 presses a side surface of the projecting portion 3E against one of the long sides 16 and 16 of the positioning hole 10. Thus, the magnetic core half 3 is strongly fixed to the base 2. Accordingly, the long side 16 of the positioning hole 10 against which the projecting portion 3E is pressed (one of the inner sides of the positioning hole 10) serves as a reference surface for positioning the magnetic core half 3.

A preferred shape of the recess 20 is shown in FIGS. 3 and 4. In the present embodiment, the recess 20 has a linear shape in a plan view and an isosceles trapezoid shape in a sectional view, and is long enough to reach the expanding portions 18 and 18 at both ends thereof. The recess 20 is formed by the indenting tool 19 having a projection 19A with a shape corresponding to the shape of the recess 20, as shown in FIG. 4.

With reference to FIG. 4, when the indenting tool 19 is moved in the direction shown by the arrow e and is pressed into the base 2, the base 2 composed of metal is plastically deformed such that a portion of the base 2 on the side of the recess 20 is shifted toward the projecting portion 3E and serves as the spreading portion 21. The spreading portion 21 presses the projecting portion 3E such that the surface of the projecting portion 3E on the side remote from the spreading portion 21 is pressed against the long side 16 which serves as the reference surface. Therefore, the magnetic core half 3 is strongly fixed to the base 2 and is positioned in the X direction.

Recesses 22 and 24 formed at the peripheries of the positioning holes 11 and 12, respectively, are constructed similarly to the recess 20 formed at the periphery of the positioning hole 10, and explanations thereof are thus omitted.

When the recess 20 is formed by the above-described indenting tool 19, since the expanding portions 18 are formed at both ends of the recess 20 in the longitudinal direction of the recess 20, a portion of the base 2 deformed by the indenting tool 19 does not easily move beyond both ends of the recess 20, and mainly moves toward the projecting portion 3E of the magnetic core half 3 from the recess 20. Therefore, a wide area of the projecting portion 3E can be efficiently pressed against the long side 16.

In addition, the indenting tool 19 is provided with a flat portion 19B at the periphery of the projection 19A. Accordingly, when the recess 20 is formed by pressing the indenting tool 19 into the surface of the base 2, a portion of the base 2 is not only shifted in the direction shown by the arrows shown in FIG. 4, but is also pushed into a space below the projecting portion 3E of the magnetic core half 3 at the bottom of the positioning hole 10, so that a projection 2A is formed.

In order to uniformly press the projecting portion 3E against the long side 16 which serves as the reference surface, the recess 20 preferably has a linear shape in a plan view. However, the shape of the recess 20 is not limited to this, and the recess 20 may have an arbitrary shape such as a rectangular shape, an elliptical shape, a circular shape, and a meandering shape in a plan view, and the length of the recess 20 is not necessarily long enough to reach the expanding portions 18 and 18 at both ends thereof. More specifically, the shape of the recess 20 is not limited as long as the spreading portion 21 can be obtained by forming the recess 20 and the projecting portion 3E can be pressed by a deformed portion of the base 2, that is, as long as deformation processing as described above can be performed.

As shown in FIG. 4, a first wall 20a of the recess 20 which is adjacent to the positioning hole 10 is inclined, and a second wall 20b of the recess 20 at the opposite side is also inclined. An inclination angle α of the first wall 20a with respect to a bottom surface 20c of the recess 20 may be smaller than an inclination angle β of the second wall 20b with respect to the bottom surface 20c. The inclination angle β of the second wall 20b with respect to the bottom surface 20c may be set in the range of 45° or more, and in particular, the inclination angle β may be set to 45° in this range.

As described above, the magnetic core half 3 is positioned in the thickness direction of the base 2 (the Z direction in FIGS. 1 and 4) by pressing the flat portion 3D against the surface of the base 2, is positioned in the thickness direction of the magnetic core half 3 (the X direction in FIGS. 1 and 4) by pressing the projecting portion 3E against the long side 16 which serves as the reference surface, and is positioned in the longitudinal direction of the magnetic core half 3 (the Y direction in FIGS. 1 and 4) by tightly or loosely fitting the projecting portion 3E into the positioning hole 10 and fixing the projecting portion 3E while both ends of the projecting portion 3E are restrained by the short sides 15. As a result, the magnetic core half 3 is positioned with respect to the base 2 in all of the X, Y, and Z directions with high accuracy.

In addition, similarly to the magnetic core half 3, the projecting portion 4E of the magnetic core half 4 is tightly or loosely fitted into the positioning hole 12, and a recess 22 shown in FIG. 1 is formed in the base 2 by the indenting tool 19 at a position between the expanding portions 18 and 18 on one side of the positioning hole 12, so that a spreading portion 23 which is shifted due to the recess 22 presses a side surface of the projecting portion 4E against one of the long sides 16 and 16 of the positioning hole 12. Accordingly, the magnetic core half 4 is strongly fixed to the base 2 and is positioned with respect to the base 2 in all of the X, Y, and Z directions with high accuracy, similarly to the magnetic core half 3.

In addition, the shield plate 5 is further provided with a projecting portion 5E which is similar to the projecting portions 3E and 4E on the back of the shield plate 5 at the central region thereof. The projecting portion 5E is tightly or loosely fitted into the positioning hole 11 formed in the base 2, and recesses 24 and 24 shown in FIG. 1 are formed in the base 2 by the indenting tool 19 at positions between the expanding portions 18 and 18 on both sides of the positioning hole 11, so that spreading portions 25 and 25 which are shifted due to the recesses 24 and 24 press the side surfaces of the projecting portion 5E against the long sides 16 and 16 of the positioning hole 11. Accordingly, the shield plate 5 is strongly fixed to the base 2, and is positioned with respect to the base 2 in all of the X, Y, and Z directions with high accuracy, similarly to the magnetic core half 3.

When the projecting portions 3E and 4E of the magnetic core halves 3 and 4, respectively, and the projecting portion 5E of the shield plate 5 are fixed by deformation processing while they are being pressed against the long sides 16 which serve as reference surfaces by the spreading portions 21, 23, and 25 obtained by forming the recesses 20, 22, and 24, respectively, stress load placed on the magnetic core halves 3 and 4 which form a magnetic circuit can be kept as low as possible. When the stress load is placed on the magnetic core halves 3 and 4 which are composed of a magnetic material, magnetostriction occurs and there is a risk that the magnetic properties as magnetic cores will be degraded depending on the degree of magnetostriction. However, by pressing mainly the projecting portions 3E and 4E against the long sides 16 which serve as positioning portions, high positioning accuracy can be obtained while preventing magnetostriction, etc., due to the stress load placed on the magnetic core halves 3 and 4 which leads to the degradation of the magnetic properties. In this view, preferably, the areas of regions outside the projecting portions 3E and 4E in the magnetic core halves 3 and 4 at which the stress load is placed by the spreading portions 21 and 22, respectively, are 10% or less of the cross-sectional areas of the magnetic core halves 3 and 4 which form magnetic paths, and are kept as low as possible. When a large pressing force is applied over large areas of portions of the magnetic core halves 3 and 4 which form main magnetic paths due to deformation processing, there is a risk in that the effective permeability (μe) of the magnetic core halves 3 and 4 composed of a magnetic material such as NiFe, which is normally about 15000, will be reduced to about 14000.

Then, after the magnetic core halves 3 and 4 and the shield plate 5 are accurately fixed to the base 2 as described above, minimum necessary amount of adhesive (not shown) is applied to parts where they are in contact with the base 2, so that the magnetic core halves 3 and 4 and the shield plate 5 are more strongly fixed. Since the magnetic core halves 3 and 4 and the shield plate 5 are already fixed relatively strongly by deformation processing as described above, the amount of adhesive required in this case is considerably smaller than the amount of adhesive used in the known technique. In addition, if a sufficiently strong fixing force is obtained by deformation processing, the adhesive may also be omitted.

In addition, as shown in FIG. 1, a bobbin 26 around which a coil is wound is attached to the back-core portion 3C of the magnetic core half 3, and a bobbin 27 around which a coil is wound is attached to the back-core portion 4C of the magnetic core half 4. A terminal rod 28 projects from the bobbin 26, and a terminal rod 29 projects from the bobbin 27.

Two magnetic core units K and K, in each of which the magnetic core halves 3 and 4 and the shield plate 5 are attached to the base 2, are disposed in the shield case 6 in such a manner that the magnetic core halves 3 and 3, the magnetic core halves 4 and 4, and shield plates 5 and 5 of the magnetic core units K and K face each other. In addition, the magnetic core halves 3 and 4 and the shield plate 5 of each magnetic core unit K slightly project from the window 6C of the shield case 6 at the front ends thereof. Then, an adhesive (not shown) is injected into the shield case 6 so that the magnetic core units K and K are fixed in the shield case 6. Thus, the magnetic head 1 is completed.

A method for assembling and manufacturing the magnetic head 1 which is constructed as described above will be described below.

First, in a relief-portion forming step, the expanding portions 18 are formed at the corners of the positioning holes 10, 11, and 12 into which the projecting portions 3E, 4E, and 5E of the magnetic core halves 3 and 4 and the shield plate 5, respectively, are inserted.

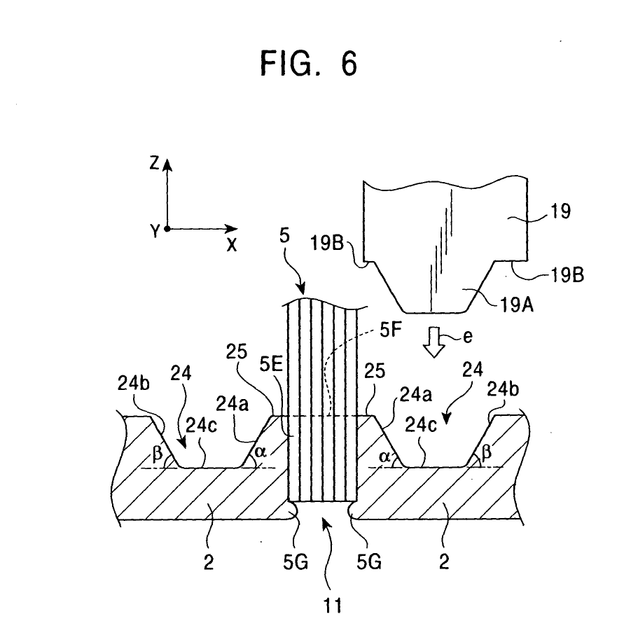

Next, in a shield-plate inserting step, the projecting portion 5E of the shield plate 5 is inserted into the positioning hole 11. At this time, since a bottom portion 5F of the shield plate 5 comes into contact with the base 2, the shield plate 5 can be positioned in the Z direction (see FIG. 6). In addition, when the shield plate 5 is attached, compared to the case in which the expanding portions 18 are not formed at the corners of the positioning hole 11, the space for receiving the shield plate 5 is ensured. Accordingly, the shield plate 5 can be extremely easily attached.

Next, in a magnetic-core-half inserting step, the projecting portions 3E and 4E of the magnetic core halves 3 and 4 are inserted into the positioning holes 10 and 12, respectively. At this time, since the main portions 3A and 4A of the magnetic core halves 3 and 4 come into contact with the base 2, the magnetic core halves 3 and 4 can be positioned in the Z direction (see FIG. 4). In addition, when the magnetic core halves 3 and 4 are attached, compared to the case in which the expanding portions 18 are not formed at the corners of the positioning holes 10 and 12, the spaces for receiving the magnetic core halves 3 and 4 are ensured. Accordingly, the magnetic core halves 3 and 4 can be extremely easily attached. Furthermore, when the projecting portions 3E and 4E of the magnetic core halves 3 and 4 are inserted into the positioning holes 10 and 12, respectively, side surfaces of the magnetic core halves 3 and 4 are pressed by the restraining tabs 7 and 8, respectively, of the base 2 and the front-end portions 3B and 4B of the magnetic core halves 3 and 4 come into contact with the shield plate 5. Accordingly, the magnetic core halves 3 and 4 cannot move freely in the Y direction in FIG. 1, and are thereby positioned in the Y direction.

Next, in a recess-forming step, the recesses 20, 22, and 24 are formed at the peripheries of the positioning holes 10, 11, and 12, respectively, by the indenting tool 19. Each of the recesses 20, 22, and 24 is connected to the expanding portions 18 at both ends thereof.

Next, as shown in FIG. 4, when the indenting tool 19 is pressed into the base 2 placed on a worktable T from above, the projection 19A sinks into the base 2 so as to form the recess 20. At this time, a portion of the base 2 between the positioning hole 10 and the first wall 20a of the recess 20 tries to move upward and make the surface of the base 2 swell as the projection 19A of the indenting tool 19 sinks into the base 2. However, this portion of the base does not move upward to make the surface of the base 2 swell since it is pressed downward by the flat portion 19B of the indenting tool 19 and upward by the worktable T, and thereby moves toward the projecting portion 3E of the magnetic core half 3.

In addition, similarly, since a portion of the base 2 adjacent to the second wall 20b of the recess 20 is pushed downward by the flat portion 19B of the indenting tool 19 and is upward by the worktable T, it does not move upward to make the surface of the base 2 swell and moves toward the magnetic core half 3.

As described above, as shown in FIG. 4, a portion of the base 2 which corresponds to at least a part of the volume of the recess 20 moves toward the spreading portion 21 positioned between the positioning hole 10 and the recess 20. Accordingly, the spreading portion 21 moves toward the projecting portion 3E of the magnetic core half 3, and presses the magnetic core half 3 against one of the inner sides of the positioning hole 10. As a result, the magnetic core half 3 can be strongly fixed.

In addition, when the indenting tool 19 is pressed into the base 2, the projection 2A is formed on an inner side of the positioning hole 10 which is adjacent to the recess 20 at a region where the inner side is not in contact with the projecting portion 3E of the magnetic core half 3. The projection 2A comes into contact with the bottom surface of the projecting portion 3E of the magnetic core half 3 so as to support the magnetic core half 3 at the bottom.

Similarly, the magnetic core half 4 can also be strongly fixed by forming the recess 22 at the periphery of the positioning hole 12 by the indenting tool 19 and pressing the projecting portion 4E of the magnetic core half 4 against one of the inner sides of the positioning hole 12.

In addition, when the indenting tool 19 is pressed into the base 2, a projection (not shown) is formed on an inner side of the positioning hole 12 which is adjacent to the recess 22 at a region where the inner side is not in contact with the projecting portion 4E of the magnetic core half 4. This projection comes into contact with the bottom surface of the projecting portion 4E of the magnetic core half 4 so as to support the magnetic core half 4 at the bottom.

In addition, as shown in FIG. 6, by forming the recesses 24 and 24 at both sides of the positioning hole 11 into which the projecting portion 5E of the shield plate 5 is inserted, portions of the base 2 on both sides of the positioning hole 11 move toward the projecting portion 5E of the shield plate 5. Accordingly, the spreading portions 25 and 25 press the shield plate 5 from both sides thereof, and the shield plate 5 can be strongly fixed.

In addition, when the indenting tool 19 is pressed into the base 2, projections 5G and 5G are formed on the inner sides of the positioning hole 11 at both sides thereof at regions where the inner sides of the positioning hole 11 are not in contact with the projecting portion 5E of the shield plate 5. The projections 5G and 5G come into contact with the bottom surface of the projecting portion 5E of the shield plate 5 so as to support the shield plate 5 at the bottom. In particular, since the recesses 24 and 24 are formed at both sides of the positioning hole 11, the shield plate 5 can be more stably supported.

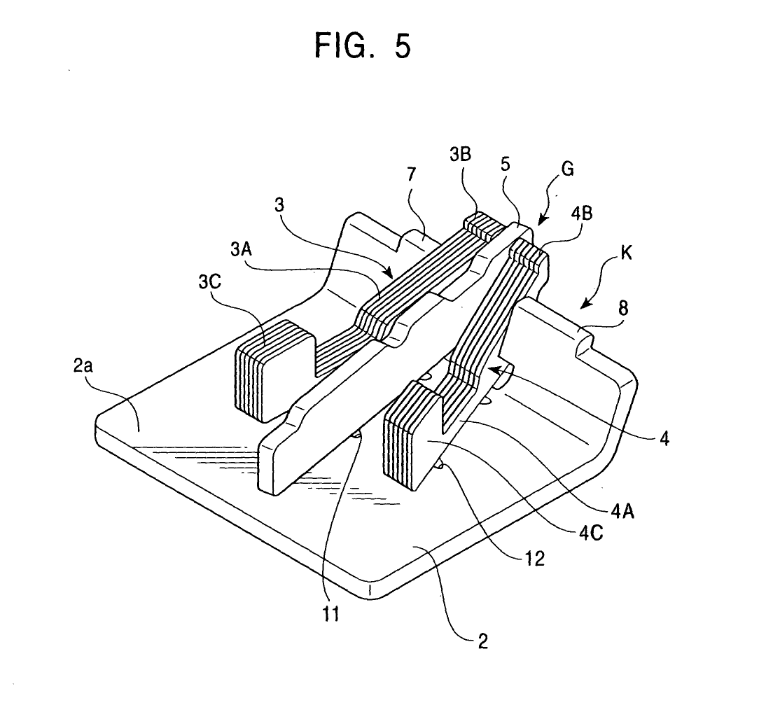

As shown in FIG. 5, the magnetic core halves 3 and 4 and the shield plate 5 are attached to the base 2 by the above-described steps. Then, as shown in FIG. 1, the bobbin 26 around which a coil is wound is attached to the back-core portion 3C of the magnetic core half 3, and the bobbin 27 around which a coil is wound is attached to the back-core portion 4C of the magnetic core half 4. Accordingly, the magnetic core unit K is manufactured.

Next, in a resin-supplying step and a drying step, an adhesive is injected into the magnetic core unit K.

Next, in a surface-grinding step, the magnetic core unit K is processed by a grinding machine (not shown) such that end surfaces of the front-end portions 3B and 4B and end surfaces of the back-core portions 3C and 4C of the magnetic core halves 3 and 4, respectively, are grinded.

Next, in a casing step, two magnetic core units K are combined and are disposed in the shield case 6 along with the spacer 14. The magnetic core units K are combined such that the front-end portions 3B and 4B of the magnetic core halves 3 and 4 of one of the magnetic core units K and the front-end portions 3B and 4B of the magnetic core halves 3 and 4 of the other magnetic core unit K face each other with a gap G therebetween.

Next, in a resin-injecting/drying step, an adhesive resin is injected into the shield case 6 and is dried and cured by heating, so that the two magnetic core units K are fixed to the shield case 6. Then, after the two magnetic core units K are fixed to the shield case 6 by the adhesive resin, a final grinding process is performed and the front wall 6B of the shield case 6 is grinded along the grinding line S, so that the sliding surface with respect to a tape-shaped magnetic medium is defined. In addition, the front-end portions 3B and 4B of the magnetic core halves 3 and 4 and a front-end portion of the shield plate 5 are grinded by a necessary amount so that the gap G is defined. Thus, the magnetic head 1 is completed by the above-described steps.

Next, the operation and effects of the magnetic head 1 according to the present invention will be described below.

As shown in FIG. 4, in the magnetic head 1 according to the present invention, after the projecting portion 3E of the magnetic core half 3 is inserted into the positioning hole 10, the recess 20 is formed at the periphery of the positioning hole 10 by the indenting tool 19. Accordingly, a portion of the base 2 which corresponds to at least a part of the volume of the recess 20 moves toward the magnetic core half 3. Therefore, due to the movement of this portion of the base 2, the spreading portion 21 positioned between the positioning hole 10 and the recess 20 moves toward the magnetic core half 3, and presses the magnetic core half 3. As a result, the magnetic core half 3 is pressed against the one of the inner sides 16 of the positioning hole 10, and the magnetic core half 3 can be strongly fixed.

In addition, the magnetic core half 4 which is inserted into the positioning hole 12 can also be strongly fixed in a similar manner.

Furthermore, by forming the recesses 24 and 24 at both sides of the positioning hole 11 along the longitudinal direction of the positioning hole 11, portions of the base 2 positioned between the positioning hole 11 and the recesses 24 and 24 (spreading portions 25 and 25) move toward the shield plate 5 and press the shield plate 5 from both sides. As a result, the shield plate 5 can be strongly fixed.

Since both ends of the recess 20 formed at the periphery of the positioning hole 10 are connected to the expanding portions 18, the volume of a portion of the base 2 positioned between the positioning hole 10 and the recess 20 (spreading portion 21) is constant along the longitudinal direction of the positioning hole 10. More specifically, since the recess 20 is not cut at intermediate positions thereof, the volume of a portion of the base 2 positioned between the positioning hole 10 and the recess 20 does not vary along the longitudinal direction of the positioning hole 10. Accordingly, when the recess 20 is formed, a portion of the base 2 (spreading portion 21) which corresponds to at least a part of the volume of the recess 20 uniformly moves toward the magnetic core half 3. As a result, the spreading portion 21 presses the magnetic core half 3 against one of the inner sides 16 of the positioning hole 10 with a force which is constant along the longitudinal direction of the positioning hole 10, and the magnetic core half 3 can be stably fixed. In addition, the magnetic core half 3 can be positioned with high accuracy.

For the same reason, the magnetic core half 4 inserted into the positioning hole 12 can also be stably fixed and be positioned with high accuracy.

In addition, as shown in FIG. 6, since the shield plate 5 is pressed from both sides by the spreading portions 25 and 25 which extend along the longitudinal direction of the positioning member 11 at both sides thereof, the shield plate 5 can be more strongly and stably fixed, and be positioned with high accuracy.

As shown in FIG. 4, in the recess 20 formed at the periphery of the positioning hole 10, the first wall 20a which is adjacent to the positioning hole 10 is inclined. Accordingly, compared to the case in which the first wall 20a is vertical, a portion of the base 2 positioned between the positioning hole 10 and the recess 20 does not move toward surface of the base 2, but moves toward the magnetic core half 3. Therefore, the pressing force applied to the magnetic core half 3 by the spreading portion 21 can be increased and the magnetic core half 3 can be more strongly fixed.

In addition, the second wall 20b of the recess 20 which is remote from the positioning hole 10 is also inclined. Accordingly, compared to the case in which the second wall 20b is not inclined, a portion of the base 2 which is adjacent to the second wall 20b moves relatively easily toward the magnetic core half 3, and the volume of a portion of the base 2 which moves toward the surface of the base 2 can be reduced by the amount of a portion of the base 2 which moves toward the magnetic core half 3. As a result, swelling of the surface of the base 2 can be prevented.

In addition, also in the recess 22 formed at the periphery of the positioning hole 12, a first wall (not shown) of the recess 22 which is adjacent to the positioning hole 12 is inclined. Accordingly, for the same reason as described above, the pressing force applied to the magnetic core half 4 by the spreading portion 23 can be increased and the magnetic core half 4 can be more strongly fixed.

In addition, a second wall of the recess 22 which is remote from the positioning hole 12 is also inclined. Accordingly, for the same reason as described above, swelling of the surface of the base 2 can be prevented compared to the case in which the second wall is not inclined.

In addition, as shown in FIG. 6, also in the recesses 24 and 24 formed at both sides of the positioning hole 11, first walls 24a and second walls 24b are both inclined. Accordingly, for the same reason as described above, the shield plate 5 can be more strongly fixed and swelling of the surface of the base 2 at regions adjacent to the second walls 24b can be prevented.

Since the expanding portions 18 are formed at four corners of each of the positioning holes 10, 11, and 12, the spaces for receiving the magnetic core halves 3 and 4 and the shield plate 5 are ensured and the magnetic head 1 can be easily assembled.

As described above, according to the magnetic head 1 of the present invention, the magnetic core halves 3 and 4 and the shield plate 5 can be positioned with respect to the base 2 in the X, Y, and Z directions and be reliably fixed to the base 2.

Next, a magnetic head according to a second embodiment of the present invention will be described below with reference to the accompanying drawings.

A magnetic head according to the present invention may also be used in a video tape recorder. A magnetic head used in a video tape recorder will be described below. In the following descriptions, explanations of the operation and effects similar to those of the magnetic head 1 according to the first embodiment will be omitted.

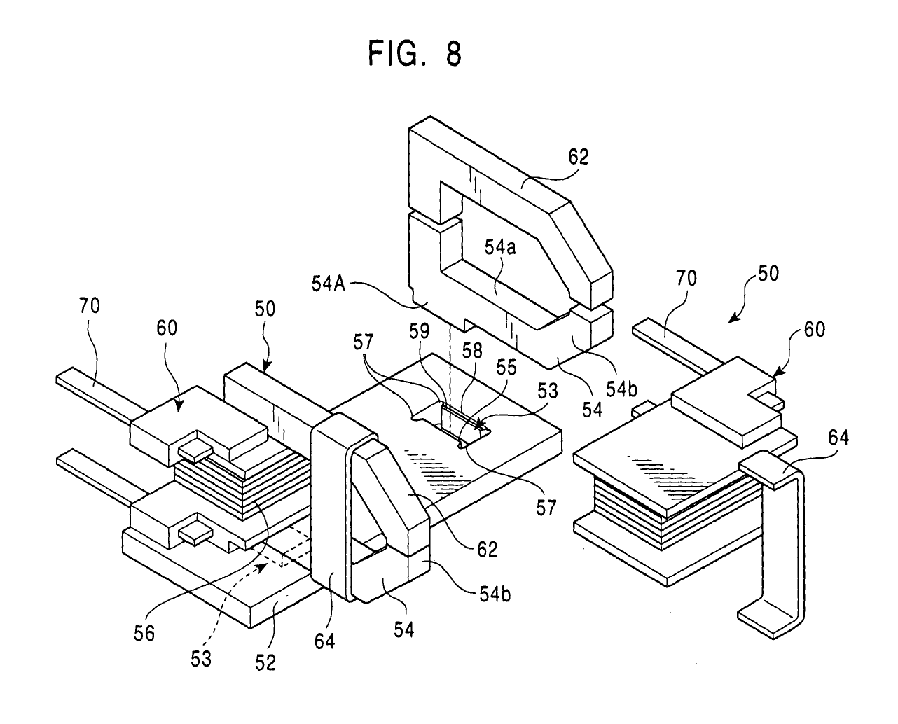

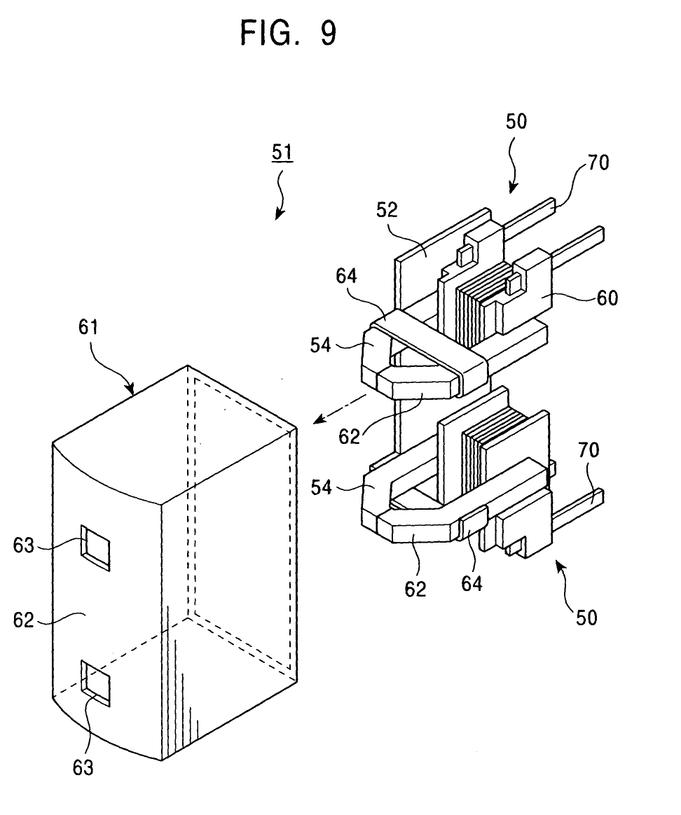

For example, FIGS. 8 and 9 show audio core units 50 used in a video tape recorder which are constructed by attaching a pair of magnetic core halves 54 to a base 52 separately from each other. The base 52 is constructed of a plate composed of brass or the like which can be subjected to plastic forming.

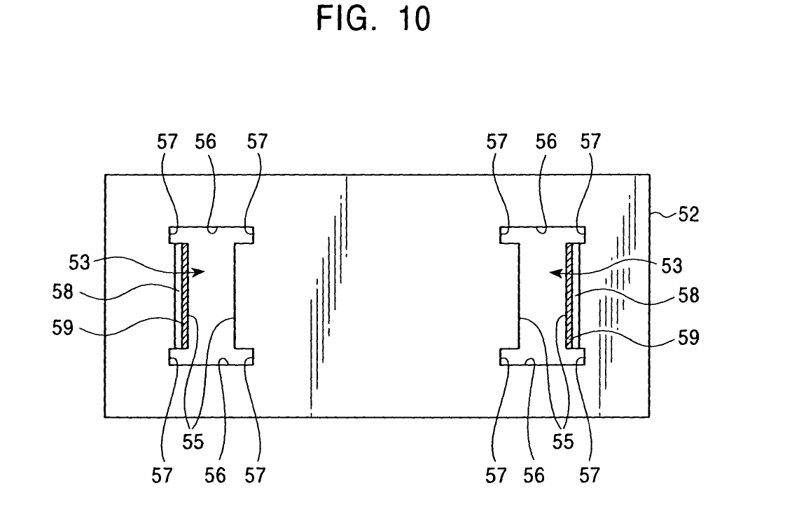

Each of the magnetic core halves 54 includes a main portion 54a and a front-end portion 54b and is attached to the base 52 by press-fitting a projecting portion 54A formed on the back of the magnetic core half 54 into one of slit-shaped positioning holes 53 formed in the base 52. As shown in FIG. 10, the positioning holes 53 in this example are basically the same as the positioning holes 10, 11, and 12 of the first embodiment, and each of the positioning holes 53 includes long sides 55 and 55, short sides 56 and 56, four expanding portions 57, and a spreading portion 59 obtained by forming a recess 58.

Each of the magnetic core halves 54 is positioned and fixed by forming the recess 58 at the periphery of the positioning holes 53 so that the spreading portion 59 obtained by forming the recess 58 presses the side surface of the projecting portion 54A against one of the long sides (reference surface) 55 of the positioning holes 53. Similar to the first embodiment, also in this case, the magnetic core halves 54 can be accurately positioned in all of the X, Y, and Z directions.

In each of the audio core units 50 used in the video tape recorder, a coil bobbin 60 having a coil 56 and a terminal rod 70 is attached to the magnetic core half 54, and the magnetic core half 54 is combined with another magnetic core half 62 with a pressing spring 62 in such a manner that the magnetic core half 54 and the magnetic core half 62 face each other.

The audio core units 50 which are constructed as described above are disposed inside a shield case 61, as shown in FIG. 9. The audio core units 50 constructed by combining the magnetic core halves 54 and 62 are fixed to the shield case 61 with an adhesive in such a manner that parts of them project through windows 63 formed in a sliding surface 62 of the shield case 61. Accordingly, a magnetic head 51 for a video recorder is completed.

The operation and effects of the magnetic head 51 according to the present embodiment will be described below.

As shown in FIGS. 8 to 10, similarly to the magnetic head 1 according to the first embodiment, also in the magnetic head 51 according to the present embodiment, when the recess 58 is formed at the periphery of the positioning hole 53 with an indenting tool, a portion of the base 52 which corresponds to at least a part of the volume of the recess 58 moves toward the projecting portion 54A. Therefore, the spreading portion 59 moves toward the projecting portion 54A and the and presses the magnetic core half 54 against one of the inner sides 55 of the positioning hole 53. As a result, this magnetic core half 54 can be strongly fixed.

Similarly, the other one of the magnetic core halves 54 cal also be strongly fixed.

In particular, since the recess 58 is connected to the expanding portions 57 at both ends thereof, similarly to the first embodiment, a pressing force which is applied to the magnetic core half 54 by the spreading portion 59 is constant along the longitudinal direction of the positioning holes 53. Accordingly, the magnetic core half 54 can be positioned with high accuracy and be stably fixed.

Similarly, the other one of the magnetic core halves 54 can also be positioned with high accuracy and be stably fixed.

In addition, since the expanding portions 57 are formed at four corners of each the positioning holes 53, the spaces for receiving the magnetic core halves 54 can be ensured and the magnetic head 51 can be easily assembled.

What is claimed is:

1. A magnetic head comprising:
at least one magnetic core unit which includes a base and at least one magnetic core half attached to the base; and
a shield case which has a window and which accommodates the magnetic core unit,
wherein the base is provided with at least one first positioning hole and the magnetic core half has a back portion which is disposed in the first positioning hole, and
wherein the base is further provided with at least one first recess at the periphery of the first positioning hole and the base is partially deformed due to the first recess such that a portion of the base at the periphery of the first positioning hole is shifted to press the back portion of the magnetic core half against an inner side of the first positioning hole.

2. A magnetic head according to claim 1, wherein the first positioning hole has a substantially rectangular shape in a plan view and includes expanding portions which increase the opening area of the first positioning hole at the corners of the first positioning hole, and
wherein the first recess connects the expanding portions on one side of the first positioning hole.

3. A magnetic head according to claim 1, wherein the first recess includes a first wall which is adjacent to the first positioning hole, the first wall being inclined with respect to the bottom surface of the first recess.

4. A magnetic head according to claim 1, wherein the first recess includes a second wall which is remote from the first positioning hole, the second wall being inclined with respect to the bottom surface of the first recess.

5. A magnetic head according to claim 1, wherein the magnetic core unit includes a plurality of the magnetic core halves and the base is provided with a plurality of the first positioning holes, each of the magnetic core halves having a back portion which is disposed in one of the first positioning holes,
wherein at least one shield plate is attached to the base such that the shield plate is disposed between the adjacent magnetic core halves,
wherein the base is provided with at least one second positioning hole at a position between the adjacent first positioning holes and the shield plate has a back portion which is disposed in the second positioning hole, and
wherein the base is further provided with at least one second recess at the periphery of the second positioning hole and the base is partially deformed due to the second recess such that a portion of the base at the periphery of the second positioning hole is shifted to press the back portion of the shield plate against an inner side of the second positioning hole.

6. A magnetic head according to claim 5, wherein the second recess includes a first wall which is adjacent to the second positioning hole and a second wall which is remote from the second positioning hole, the first wall and the second wall being inclined with respect to the bottom surface of the second recess.

7. A magnetic head according to claim 1, wherein the first recess is provided adjacent to at least one of longitudinal sides of the first positioning hole.

8. A magnetic head according to claim 1, wherein the magnetic core half includes a plurality of magnetic plates which are laminated to each other, and
wherein the base is provided with a position-restricting portion which restricts the position of the magnetic core half by pressing the magnetic core half.

9. A magnetic head according to claim 3, wherein the first recess includes a second wall which is remote from the first positioning hole, the second wall being inclined with respect to the bottom surface of the first recess.

10. A magnetic head according to claim 9, wherein an inclination angle of the first wall of the first recess with respect to the bottom surface of the first recess is smaller than an inclination angle of the second wall of the first recess with respect to the bottom surface of the first recess.

11. A magnetic head according to claim 6, wherein an inclination angle of the first wall of the second recess with respect to the bottom surface of the second recess is smaller than an inclination angle of the second wall of the second recess with respect to the bottom surface of the second recess.

12. A magnetic head according to claim 1, wherein the first positioning hole is provided with a projection on an inner side thereof, the projection being in contact with at least a part of the magnetic core half.

13. A magnetic head according to claim 5, wherein the second positioning hole is provided with a projection on an inner side thereof, the projection being in contact with at least a part of the shield plate.

14. A magnetic head according to claim 1, wherein the back portion of the magnetic core half includes a contact portion which is in contact with the surface of the base and a projection provided on the contact portion, the projection being disposed in the first positioning hole.

15. A magnetic head according to claim 5, wherein the back portion of the shield plate includes a contact portion which is in contact with the surface of the base and a projection provided on the contact portion, the projection being disposed in the second positioning hole.

16. A magnetic head comprising:
at least one magnetic core unit which includes a base, a plurality of magnetic core halves attached to the base, and at least one shield plate attached to the base such that such that the shield plate is disposed between the adjacent magnetic core halves; and
a shield case which has a window and which accommodates the magnetic core unit,
wherein the base is provided with at least one second positioning hole and the shield plate has a back portion which is disposed in the second positioning hole, and
wherein the base is further provided with at least one second recess at the periphery of the second positioning hole and the base is partially deformed due to the second recess such that a portion of the base at the periphery of the second positioning hole is shifted to presses the back portion of the shield plate against an inner side of the second positioning hole.

17. A magnetic head according to claim 16, wherein the second positioning hole has a substantially rectangular shape in a plan view and includes expanding portions which increase the opening area of the second positioning hole at the corners of the second positioning hole, and
wherein the second recess connects the expanding portions on one side of the second positioning hole.

18. A magnetic head according to claim 1, wherein the magnetic head includes a pair of the magnetic core units which are combined together such that a gap portion is provided between the magnetic core halves of the magnetic core units, and
wherein the magnetic core units are stored in the shield case such that the gap portion faces out through the window of the shield case.

19. A method for manufacturing a magnetic head including at least one magnetic core unit and a shield case which has a window and which accommodates the magnetic core unit, the magnetic core unit including a base and at least one magnetic core half which has a back portion and which is attached to the base, the method comprising:
a magnetic-core-half-inserting step of inserting the back portion of the magnetic core half into a first positioning hole which is formed in the base; and
a recess-forming step of forming at least one first recess at the periphery of the first positioning hole so that the base is partially deformed and a portion of the base at the periphery of the first positioning hole is shifted to press the back portion of the magnetic core half against an inner side of the first positioning hole.

20. A method for manufacturing a magnetic head according to claim 19, wherein the first positioning hole has a substantially rectangular shape in a plan view and the method further comprises an expanding-portion-forming step of forming expanding portions which increase the opening area of the first positioning hole at the corners of the first positioning hole, the expanding-portion-forming step being performed before the recess-forming step, and
wherein the first recess is formed so as to connect the expanding portions on one side of the first positioning hole in the recess-forming step.

21. A method for manufacturing a magnetic head including at least one magnetic core unit and a shield case which has a window and which accommodates the magnetic core unit, the magnetic core unit including a base, a plurality of magnetic core halves attached to the base, and at least one shield plate which is attached to the base such that the shield plate is disposed between the adjacent magnetic core halves and which has a back portion, the method comprising:
a shield-plate-inserting step of inserting the back portion of the shield plate into a second positioning hole which is formed in the base; and
a recess-forming step of forming at least one second recess at the periphery of the second positioning hole so that the base is partially deformed and a portion of the base at the periphery of the second positioning hole is shifted to press the back portion of the shield plate against an inner side of the second positioning hole.

22. A method for manufacturing a magnetic head according to claim 21, wherein the second positioning hole has a substantially rectangular shape in a plan view and the method further comprises an expanding-portion-forming step of forming expanding portions which increase the opening area of the second positioning hole at the corners of the second positioning hole, the expanding-portion-forming step being performed before the recess-forming step, and
wherein the second recess is formed so as to connect the expanding portions on one side of the second positioning hole in the recess-forming step.

23. A method for manufacturing a magnetic head according to claim 19, wherein the first recess is formed with an indenting tool in the recess-forming step, and
wherein the indenting tool includes a projection which is pressed into the base and a flat portion which comes into contact with the surface of the base and prevents the surface of the base from swelling when the projection is pressed into the base.

24. A method for manufacturing a magnetic head according to claim 21, wherein the second recess is formed with an indenting tool in the recess-forming step, and
wherein the indenting tool includes a projection which is pressed into the base and a flat portion which comes into contact with the surface of the base and prevents the surface of the base from swelling when the projection is pressed into the base.
